(19) United States
(12) Patent Application Publication
(10) Pub. No.: US 2005/0029690 A1
(43) Pub. Date: Feb. 10, 2005

(54) Method and apparatus for manufacturing compressed earthen blocks

(76) Inventors: George Burlow, Vereeniging (ZA); Gert Byleveldt, Benoni (ZA); Julian Bryan Hutchins, Sandton (ZA); Richard A. Ryerson, Pella, IA (US); Thomas R. Haley, Pella, IA (US)

Correspondence Address: STURM & FIX LLP, 206 SIXTH AVENUE, SUITE 1213, DES MOINES, IA, 50309-4076, US

(21) Appl. No.: 10/912,491

(22) Filed: Aug. 5, 2004

Related U.S. Application Data
(60) Provisional application No. 60/493,512, filed on Aug. 8, 2003.

(51) Int. Cl. B29C 43/04

(52) U.S. Cl. 264/40.4; 425/412; 264/109

(57) ABSTRACT

A machine and method for producing dimensionally consistent compressed earthen blocks under consistent and uniform pressures is disclosed. The approximately rectangular shaped block is formed in a rectangular parallelepiped shaped chamber having given dimensions. A plate forms one wall of this chamber and has the mobility required to compress the earth within the chamber. At the termination of compression, this plate is located at a predetermined location. A dog is forced into the compressed earthen block after the compression plate has ceased which effectively reduces the internal volume of the chamber. The dog is forced in under a known and consistent pressure. When a block is formed of less material, the terminal point for the dog will be further into the block than when the same-size block is made of more material. Additional aspects include a calibration unit for determining a volume of raw material to load into the compression chamber; and a hydraulic cylinder able to actuate two coaxial rams independently.

### CROSS REFERENCE TO RELATED APPLICATIONS

This application contains disclosure from and claims the benefit under Title 35, United States Code, §119(e) of the following U.S. Provisional Application: U.S. Provisional Application Ser. No. 60/493,512 filed Aug. 8, 2003, entitled BLOCK MAKING APPARATUS.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

This invention relates to building material. More particularly, the invention relates to a method and apparatus for making building blocks. In particular, the invention relates to an apparatus and method for the manufacture of compressed-earth building blocks. Further, the invention relates particularly to the manufacture of compressed stabilized building blocks of soil or earth that have a good degree of dimensional accuracy and uniformity or density using a primary and secondary compression method.

2. Background Art

Many forms of building block are known for use in construction of building structures. One form of such building block comprises particulate earth or soil which is compressed in a mold to form the building block. Such building blocks are sometimes known by the names “soil blocks,” “earthen blocks,” or “Compressed Earth Blocks” (CEB). The raw material for such blocks may comprise earth of varying types, together, optionally, with suitable stabilizers, such as cementitious materials, liquid for hydration of the cementitious material, sealants, waterproofing agents, fillers, and the like. In order to reduce handling costs during construction, such building blocks are generally large in comparison with traditional fired clay bricks.

Presently, two approaches are used in the manufacture of compressed earthen building blocks:
1. consistent final pressure, inconsistent dimensions, or
2. consistent dimensions, inconsistent density.
   Because the raw materials used in the manufacture of the compressed earthen building blocks varies in character, and because the volume of material may vary slightly between blocks, if all the blocks are made to a specified size, the terminal pressures will vary from finished block to finished block, and thus their densities. On the other hand, if a given terminal pressure is consistently reached, due to the varying characteristics and volume of the raw materials, the blocks will vary in at least one of their terminal dimensions.

Another problem encountered in the manufacture of compressed earthen building blocks is the achievement of homogeneity throughout the building block. To achieve a homogeneous building block of even density throughout the block, it is necessary to achieve even pressures throughout the raw material of the building block during the manufacturing process. This has proved a challenge. The raw material used in the manufacture of such blocks is of a particulate nature and the transmission of even compressive forces throughout a large volume of such material is difficult to achieve. Traditionally, such building blocks have been manufactured in a compression chamber, or mold, of generally rectangular parallelepiped shape. One side of the mold is displaceable to act as a ram for compression of the raw material within the compression chamber. In such devices, it is found that it is possible to achieve relatively high pressures for compression proximate the ram, but that the pressures within the cavity of the compression chamber drop off towards the distal end of the chamber. In order to achieve acceptable compression at the distal end of the chamber, it is necessary to apply large ram forces to the raw material, thereby necessitating the use of heavy and expensive equipment and the consumption of relatively large amounts of energy. It has also been found that even where the requisite even distribution of pressure is achieved within the raw material in the compression chamber, it is difficult to achieve dimensional consistency of the finished block.

A machine for the manufacture of compressed earthen building blocks is disclosed by Rose in U.S. Pat. No. 4,563,144. The raw materials used to make the building blocks are loaded into a hopper. A plunger beneath the hopper measures out a given sample of these materials and loads them into a compression chamber where they are compressed into a compressed earthen building block. No provision is made for the varying conditions of the raw materials and the adjustment of the initial volume thereof. According to the specification, the building blocks are formed to a consistent pressure. The implication of this is that the building blocks will vary in terminal size. For the purpose of this document, “terminal size” is defined as the size of the compressed earthen building blocks when they are expelled from the compression chamber. The compressed earthen building blocks will vary somewhat from their terminal size during further curing.

Another machine for the manufacture of compressed earthen building blocks is disclosed by Lienau in U.S. Pat. No. 5,629,033. In this invention, a feeder box is provided under the hopper. The raw materials drop from the hopper into the feeder box, and are transported over the compression chamber. A wedge is provided at the top cover of the compression chamber, the wedge being forced under a bucking bar that extends entirely across the compression chamber. Thus, the top cover is secured over the compression chamber.

Lienau discloses a method for producing blocks of consistent dimension and density by varying the starting point of the press ram, and thus the quantity of raw materials entering the compression chamber. According to the specification, the starting position of the press ram is found by trial and error. No provision for achieving homogeneous density in the finished block is disclosed by Lienau.

There is, therefore, a need for a method and apparatus for producing compressed earthen building blocks of consistent dimension and density, as well as homogeneous density. There is an additional need for a method and apparatus for determining, without trial and error, a quantity of raw material to insert into the compression chamber to produce blocks of consistent dimension and density.

There is still another need for a method and apparatus for inserting a compression element, or “dog,” into the dimensioned, compressed earthen building block, and an actuator system for effecting this insertion to achieve homogeneity of density throughout the finished block.

### BRIEF SUMMARY OF THE INVENTION

It is an object of the invention to provide a block making apparatus and method for making compressed earthen building blocks which will, at least partially, alleviate the abovementioned problems, enabling the manufacture of building blocks of high dimensional accuracy and homogeneity, as well as having dimensional consistency.

To effect the abovementioned objects, the apparatus for manufacturing the compressed earthen building blocks has a compression chamber in which the compressed earthen building blocks are compressed. One wall is typically movable under force of a hydraulic cylinder or other actuation device.

In addition, at least one compression element, referred to herein as a “dog,” is forced into the block after the movable wall has reached its desired terminal location. Thus, at least one cavity is produced in the block to compress the block material to its final compression value. The terminal pressure of the ram or rams for inserting the at least one dog is fixed. Therefore, the distance a dog enters the block will vary depending on the initial volume of earth used for the block, and the characteristics of that earth.

(For the purposes of this specification, “dog” is defined as a compression element, inserted into a compressed earthen building block for the purpose of enhancing the homogeneity of, and achieving the desired density of the compressed earthen building block. The dog may take on any of a variety of shapes. A single dog, or a plurality of dogs may be used in the manufacture of a given compressed earthen building block.)

The compression chamber may comprise a first pair of generally parallel side walls, intermediate a second pair of generally parallel front and rear walls. Further, a fifth wall of the chamber may comprise a pressure plate which is displaceable with respect to the front, rear and side walls to slide within a rectangular cylinder defined by these walls. An end of the chamber opposed to the compression plate is openable and the apparatus includes a removable cover operable between a first position in which it is clear of the opening of the compression chamber, for filling the compression chamber with raw material, and a second position in which it operates to close the opening of the chamber and provide a sixth wall for the chamber, thus providing a closed chamber for compressing the raw materials into a compressed earthen building block. Hence, the chamber may be generally parallelepiped in shape when all of the walls are in place, although any of the walls may have formations defined thereon to produce complimentary formations in the building block formed in the chamber.

The at least one dog is generally cylindrical, having any number of suitable cross-sectional shapes, and is received within an aperture of complementary shape in the pressure plate of the compression chamber. Further, the end of the dog away from the ram by which it is inserted into the block is preferably tapered or rounded. Hence, its penetration is facilitated into the raw material from which the building block is manufactured and to distribute the compression forces to the raw material in the compression chamber more evenly. In one embodiment of the invention, there are two such dogs symmetrically spaced with respect to the pressure plate, axes of the dogs being parallel. Then, the dogs may be independently displaceable with respect to the pressure plate. In a second embodiment, a single dog is used, generally having a “dog bone” or “dumbbell” cross-sectional shape—with larger ends and a narrower middle section.

The pressure plate and the dogs are displaced by means of actuators. In a preferred embodiment, the hydraulic actuator comprises an outer cylinder, a hollow ram inside the outer cylinder, and an inner, solid ram inside the hollow ram. The hollow ram and the solid ram are actuated individually. The outer ram is used to provide the force required to displace the compression plate to reduce the volume of the earth and other raw materials to the block's terminal size. The inner, solid ram is used to actuate the at least one dog.

The cover for the pressure chamber may also be operable under control of an actuator, such as a hydraulic cylinder. Operation of the actuators may be controlled by a control means, which may be a computer processor. Thus, operation of the block making apparatus may be automated.

Further, each dog includes at least one pin, an axis of which is parallel to the direction of travel of the dogs, to define a passageway between the free end of the dog and the cover of the compression chamber, thereby creating a passageway through the building block.

It will be appreciated that there is an advantage to use such a building block manufacturing apparatus in situ. Thus, the apparatus may be mounted on a vehicle, trailer, or cart to enable it to be transported to and from a building site. Further, a mixer for mixing the raw material of the building blocks may be included in the apparatus on the trailer, as may a suitable reservoir for hydraulic fluid, pumps for driving the hydraulic cylinders, and an electric generator coupled to an internal combustion engine for powering the pumps and for providing electrical power on site. Alternatively, the pumps may be powered directly from the engine.

The method of manufacture of compressed earthen building blocks includes an initial pre-compression stage, in which the raw materials for the building block are partially compressed and contained within a space of predetermined, terminal outer dimensions. The pre-compression step is by means of the pressure plate. The pressure plate provides a wall of the compression chamber to define the predetermined, terminal dimensions of the block.

As a second stage of manufacture, the at least one dog is urged into the block material in the compression chamber under the action of a predetermined force. In this step, the outer dimensions of the block are not altered, but the block material is significantly compressed, enhancing the overall compression of the block, as well as the homogeneity of the compression.

During the previous two steps, at least one passageway is formed entirely through the raw material in the compression chamber. At least one static pin associated with each dog extends from the free end of the dog to the cover plate of the compression chamber. The dog slides along the pin.

After the block has reached its terminal dimension and the final compression step has been carried out using the at least one dog, the compressed earthen building block is removed from the compression chamber. The step of removing the building block from the compression chamber is carried out by urging the building block from the chamber by means of the pressure plate until the block is at least significantly removed from the compression chamber. The building block so removed from the compression chamber may be discharged laterally by the action of the feeder box actuated by a hydraulic cylinder.

Commonly, the compression chamber has a parallelepiped shape. However, other shapes may be envisioned. In fact, mold plates of different profiles can be readily replaced, enabling compressed earthen building blocks of various profiles to be made, including special purpose and interlocking blocks.

A difficulty arises in determining how much raw material to load into the compression chamber to produce a satisfactory compressed earthen building block. Trial and error is usually required, especially when using a new batch of earth having different characteristics than previous batches. A technique to overcome this difficulty is to utilize a small sample of the earth and other raw materials used to make the compressed earthen building blocks and place the sample under the same pressure as the blocks will experience. The amount of compression of the block material is measured and the result translated to the amount of raw material needed to make a full compressed earthen building block. A special system in the hopper of the compressed earthen building block manufacturing machine provides the appropriate volume of raw material for each block.

To determine the compressibility of a sample of raw materials, an accurately bored cylinder is used. The cylinder is charged, level full, with the raw materials. This defines the initial volume. A force is applied to the raw materials such that the pressure on the materials is equal to that applied by the compressed earthen building block machine described previously. The predetermined pressure is applied in one embodiment by a weight and lever arrangement. In a second embodiment, springs are used to apply the requisite force. In still another embodiment, the force is applied by a hydraulic jack.

Regardless of the source of the force used to compress the raw materials, the compression of the sample is measured. The change in volume in the sample divided by the initial volume of the sample will be approximately equal to the expected change in volume of the compressed earthen building block material divided by its initial volume. In this way, the initial volume of the block raw materials may be calculated.

### BRIEF DESCRIPTION OF THE DRAWINGS

FIG. 1 is sectional end view of an apparatus, in accordance with the invention, for making a building block;

FIG. 2 is a sectional side view of the apparatus of FIG. 1;

FIG. 3 shows a compression element of the apparatus of FIGS. 1 and 2, in a first position;

FIG. 4 shows the compression element of FIG. 3, in a second position;

FIG. 5 is a side view of an alternative embodiment of the compression element of the apparatus;

FIG. 6 is a plan view of the compression element of FIG. 5;

FIG. 7 is a schematic view of the apparatus of the invention, in a first stage of operation;

FIG. 8 is a schematic view of the apparatus of the invention, in a second stage of operation;

FIG. 9 is a schematic view of the apparatus of the invention, in a third stage of operation;

FIG. 10 is a schematic view of the apparatus of the invention, in a fourth stage of operation;

FIG. 11 is a schematic view of the apparatus of the invention, in a fifth stage of operation;

FIG. 12 is a schematic view of the apparatus of the invention, in a sixth stage of operation;

FIG. 13 is a schematic view of the apparatus of the invention, in a seventh stage of operation;

FIG. 14 is a first perspective view of the compressed earthen building block apparatus;

FIG. 15 is a second perspective view of the compressed earthen building block apparatus;

FIG. 16 is a first perspective view of the compressed earthen building block apparatus with dust covers removed for clarity and with the cover on the compression chamber;

FIG. 17 is a second perspective view of the compressed earthen building block apparatus with dust covers removed and an open compression chamber;

FIG. 18 is a third perspective view of the compressed earthen building block apparatus with dust covers removed and a covered compression chamber;

FIG. 19 is a third perspective view of the compressed earthen building block apparatus with dust covers removed;

FIG. 20 is a detail perspective view of a wedge and rollers for sealing the compression chamber;

FIG. 21 is a fourth perspective view of the compressed earthen building block apparatus mounted on a cart for transport;

FIG. 22 is a schematic showing additional details of the invention;

FIG. 23a is a detail view of a conventional wedge and rollers for sealing the compression chamber;

FIG. 23b is a detail view of a stepped wedge and rollers for sealing the compression chamber;

FIG. 24 is a detail perspective view of a compression chamber containing a single dog;

FIG. 25 is a top plan view of a dog;

FIG. 26 is a side elevation of a hydraulic cylinder assembly able to individually actuate two separate rams;

FIG. 27 is a side elevation view of a first embodiment of a calibration unit for determining an initial volume of raw material to load into the compression chamber;

FIG. 28 is side elevation view of three examples of a second embodiment of a calibration unit for determining an initial volume of raw material to load into the compression chamber;

FIG. 29 is a side elevation view of a disc spring used in the second embodiment of the calibration unit;

FIG. 30 is a spring characteristics plot showing force versus displacement for a disc spring;

FIG. 31 is a side elevation view of a third embodiment of a calibration unit for determining an initial volume of raw material to load into the compression chamber;

FIG. 32a is a side elevation view of the hopper showing a first device for varying an amount of charge of raw materials loaded into the hopper;

FIG. 32b is a perspective view of the hopper showing a first device for varying an amount of charge of raw materials loaded into the hopper;

FIG. 33a is a side elevation view of the hopper showing a second device for varying an amount of charge of raw materials loaded into the hopper; and

FIG. 33b is a perspective view of the hopper showing a second device for varying an amount of charge of raw materials loaded into the hopper.

### DETAILED DESCRIPTION OF THE INVENTION

In the drawings, reference numeral 10 generally refers to an apparatus, in accordance with the invention, for making a compressed earthen building block.

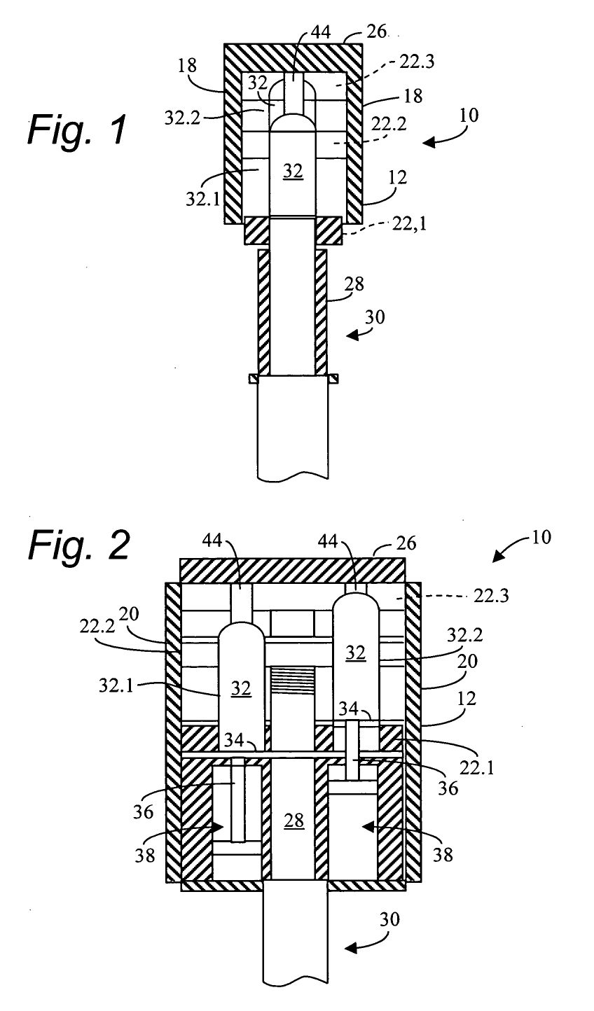

As shown in FIGS. 1-13, the compressed earthen building block manufacturing apparatus 10 has a compression chamber 12 for compressing raw material 14 for the building block to form the block 16. The raw material 14 is typically earth, of which a large number of suitable compositions are available, together with a stabilizing material, such as cement or other cementitious material, to which is added sufficient water to hydrate the stabilizing material, and, optionally, waterproofing or sealing agents and fillers, such as ash. The building block 16 is thus of the type known as a compressed earthen building block.

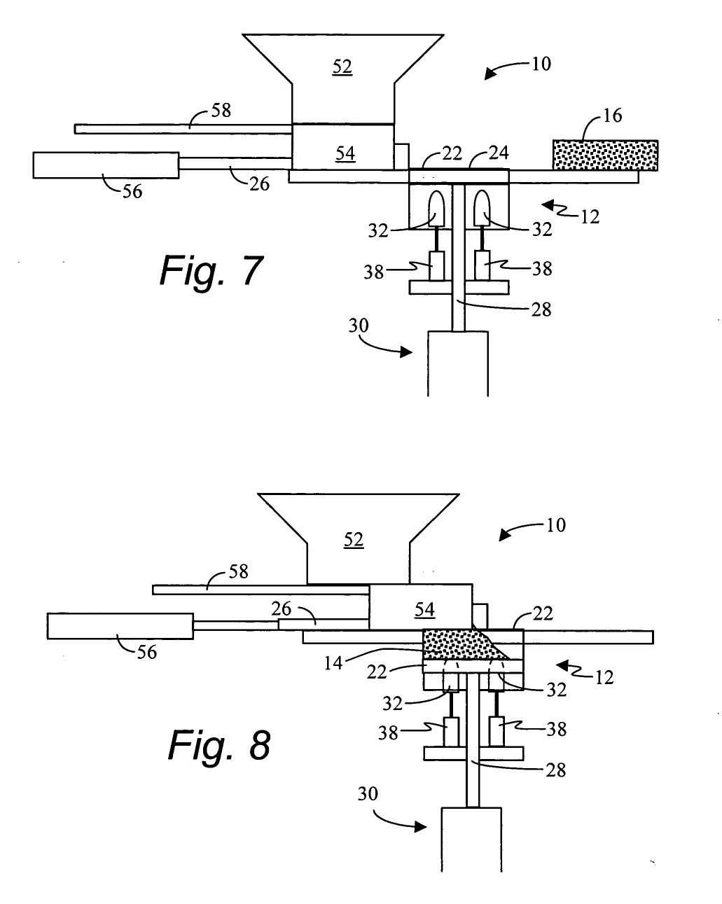

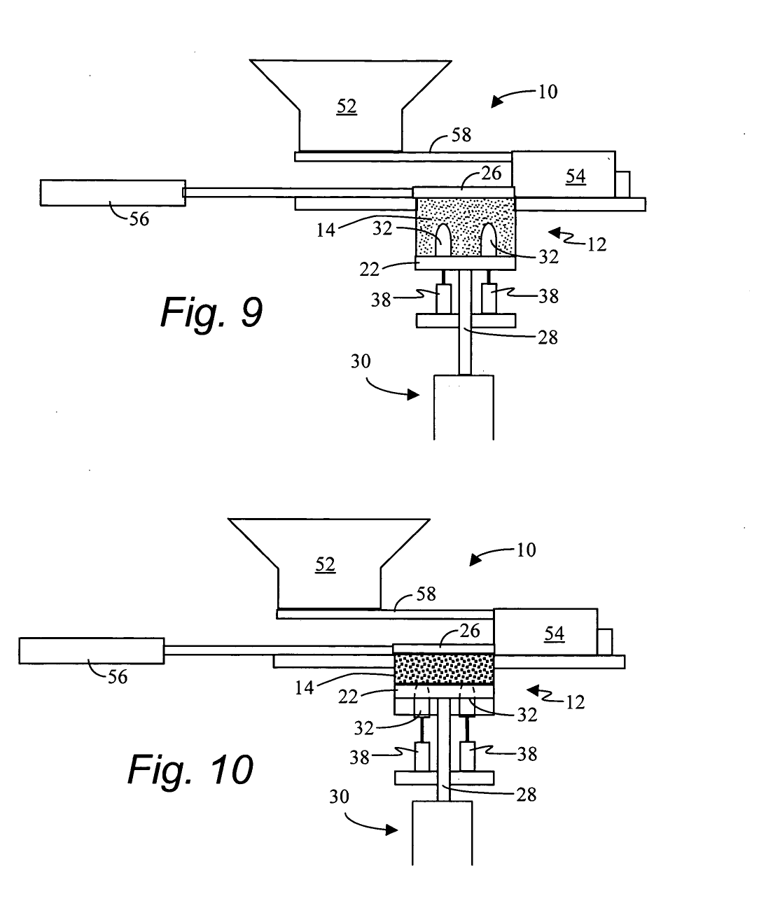

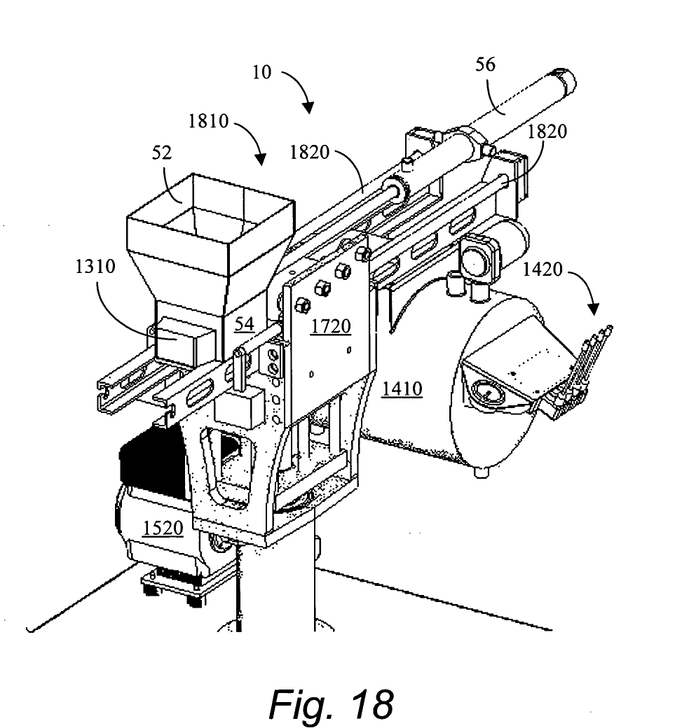

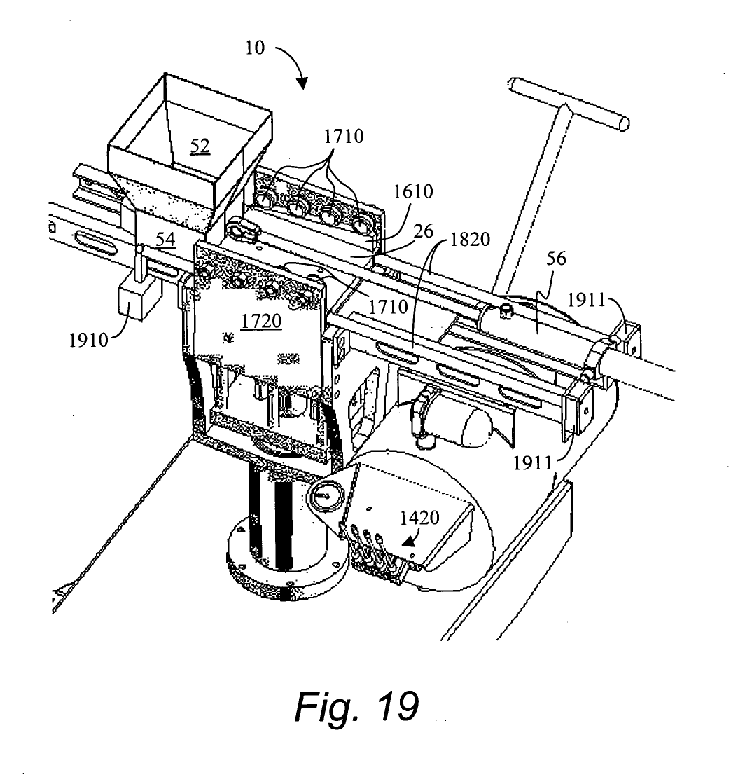

The compression chamber 12 comprises a pair of co-planar spaced apart side walls 18 and a pair of co-planar spaced end walls 20. Further, a displaceable pressure plate 22 forms a bottom wall of the compression chamber 12. The pressure plate 22 is displaceable within the side and end walls 18, 20 to move slidingly in relation thereto. An operatively upper end 24 of the compression chamber 12 is open and is closed by means of a cover 26 in the form of a plate, comprising the sixth wall of the chamber 12. The cover plate 26 is moved in a sliding manner along guide rods 1820 (see FIGS. 18-19), from a first position, in which it is clear of the opening 24 to permit loading and unloading of the chamber 12, as shown in FIG. 7, and a second position, as shown in FIG. 9, in which it forms the sixth wall of the chamber 12, sealing it for compression. The pressure plate 22 is mounted on the piston 28 of a hydraulic cylinder assembly 30, which acts as an actuator for displacing the pressure plate 22.

Although a compression chamber 12 having a parallelepiped shape is shown in this disclosure, other shapes may be envisioned. In fact, mold plates of different profiles can be readily replaced, enabling compressed earthen building blocks 16 of various profiles to be made, including special purpose and interlocking blocks.

Further, the apparatus 10 has a pair of generally circular cylindrical compression elements, or dogs 32 (although the dog or dogs of the present invention are not limited to a specific shape), each of which is mounted at its operatively lower end 34 to a piston 36 of a hydraulic cylinder assembly 38, thereby enabling the compression element 32 to be displaced axially between a first position, as shown by the compression element 32.1 of FIG. 2, and second position, as shown on by the compression element 32.2 of FIG. 1. The compression elements 32 are axially displaceable independently of the pressure plate 22 and are received through circular apertures defined in the pressure plate 22.

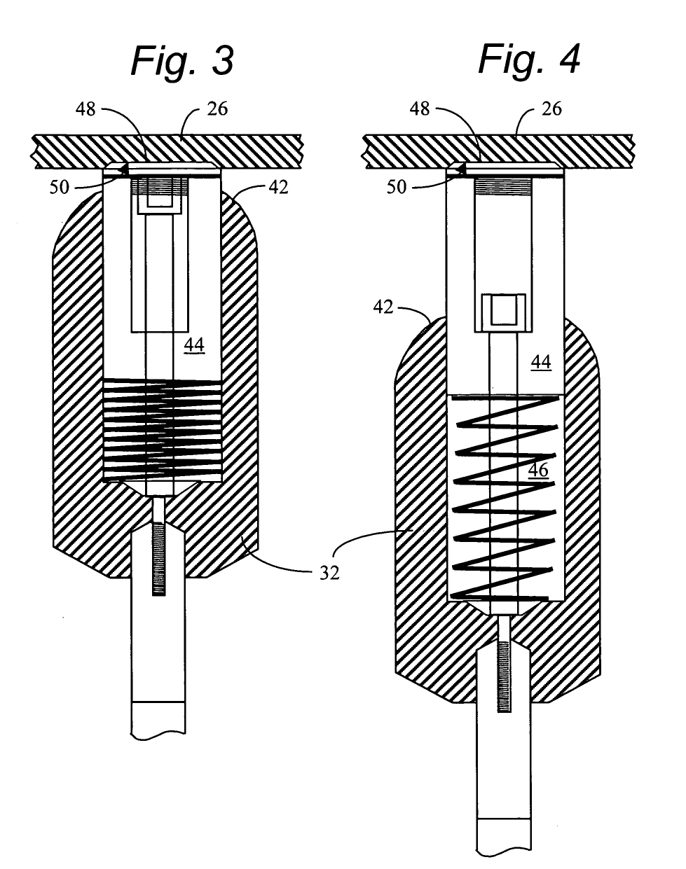

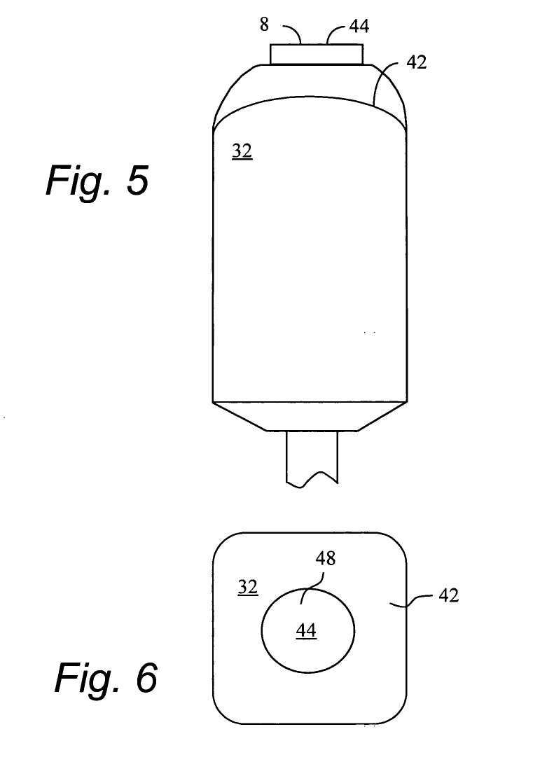

Still further, each of the compression elements 32 is radiused at its free end 42, although the present invention is not limited thereto. Each of the compression elements 32 also carries a circular cylindrical pin 44 at its free end. As shown in FIGS. 3 and 4, the pin 44 is received in an axial bore 46 defined in the compression element 32 and is spring-loaded to be axially displaceable with respect to its associated compression element 32. Thus, the pin 44 may move between an extended position, as shown in FIG. 4, and a retracted position, as shown in FIG. 3. The free ends 48 of the pins 44 are received in locating recesses 50 defined in the cover 26 of the compression chamber 12 so that, in use, when the pins 44 are located in their associated recesses 50, a pathway is defined through the raw material 14 of the building block 16 in the compression chamber 12. It will be appreciated that the compression elements 32 may be of a variety of shapes. As an example, it has been found that a compression element having a generally rectangular cross-section with radiused corners, as shown in FIGS. 5 and 6 of the drawings, provides a good distribution of compressive forces in the building block.

Turning now to FIGS. 7 to 13, the apparatus 10 and method for manufacturing compressed earthen building blocks is illustrated at various stages of operation, schematically. In addition to the compression chamber 12 of the apparatus 10, as shown in FIGS. 1 and 2, the apparatus 10 also includes a raw material hopper 52, a feeder box 54, and a horizontally oriented hydraulic actuating cylinder 56 connected to the cover plate 26 of the chamber 12. Not shown in the drawings but included in the apparatus are a hydraulically driven mixer for mixing the raw material 14 composition, a hydraulic fluid reservoir, and a hydraulic pump which, in the preferred embodiment, is driven by an electric motor under power from an electric generator which is driven by an engine, for actuating the hydraulic cylinders of the apparatus 10. All of the component parts of the apparatus 10 are secured to a trailer (not shown) and may be towed for use on site. It will be appreciated that the engine may be a gasoline or diesel engine and that the engine may drive the pump directly, rather than via an electric system.

In FIG. 7, the feeder box 54 is located immediately under the hopper 52 and has been filled with raw material 14. The cover plate 26 of the compression chamber 12 is clear of the compression chamber 12 so that the compression chamber 12 is open and its operatively upper end 24. The pressure plate 22 of the compression chamber 12 is at its upper limit, having urged a compressed earthen building block 16 out of the chamber 12, thereby extruding the compressed earthen building block 16 from the chamber 12. The compressed earthen building block 16 is shown on a conveyor, having been pushed away from the chamber 12 by the horizontal hydraulic cylinder 56.

In FIG. 8, the feeder box 54 has been moved, under actuation of the horizontal hydraulic cylinder 56, towards the compression chamber 12. Simultaneously, the hopper 52 is closed by means of a closing plate 58 which is connected to the feeder box 54. As the feeder box 54 begins to discharge its load into the compression chamber 12, the pressure plate 22 begins to drop to its lower limit (as illustrated by the pressure plate reference by reference numeral 22.1 in FIG. 2) and the compression elements 32 also return to their lower position.

In FIG. 9, the compression chamber 12 has been charged via the feeder box 54 with a predetermined volume or weight of raw material 14 and, actuated by the horizontal hydraulic cylinder 56, the feeder box 54 and cover plate 26 have been positioned so that the compression chamber 12 is closed off by the cover plate 26. The compression chamber 12 is now sealed.

In FIG. 10, a first stage of pre-compression has been completed and the pressure plate 22 has moved to a position where, together with the remaining walls 18, 20 and cover plate 26 of the compression chamber 12, the external dimensions of the block 16 are determined and a degree of pre-compression of the raw material 14 of the building block 16 has been achieved. The position of the pressure plate 22 is indicated by the numeral 22.2 in FIG. 2. The dogs 32 are still in their retracted position. Thus, the raw material 14 of the building block 16 has been partly compressed and the size of the block 16 is determined.

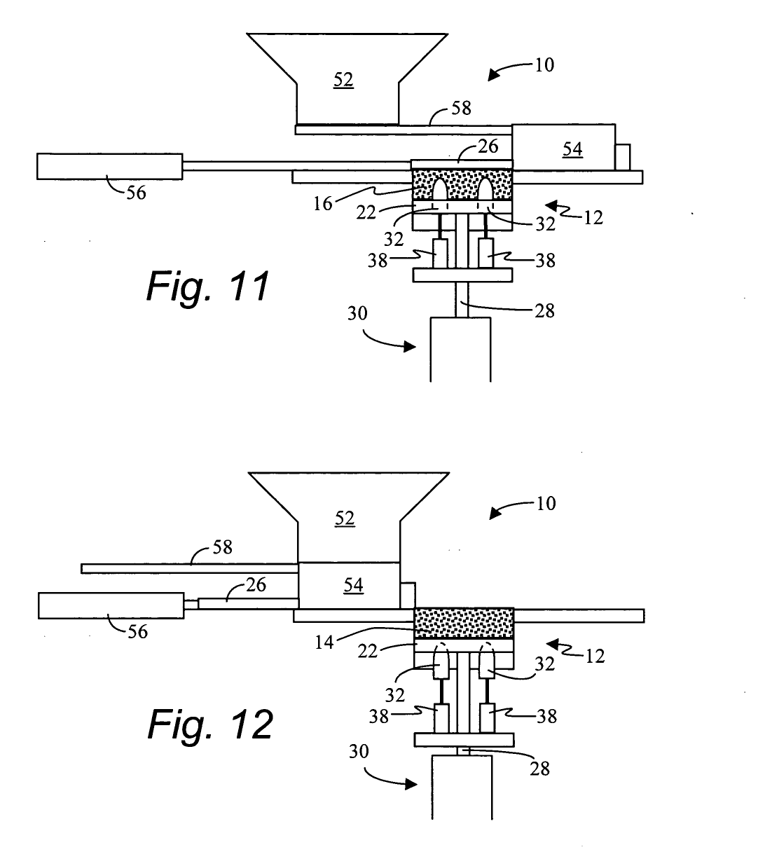

In FIG. 11 the dogs 32 are urged, under operation of their respective hydraulic cylinders 38, into the raw material 14 within the compression chamber 12 and the pins 44 of each of the compression elements 32 locate in their respective recesses 50 in the cover plate 26 to form the passageways in the block 16. Each of the dogs 32 is urged into the partially compressed raw material 14 under a predetermined pressure (as shown by the dog 32.2 in FIG. 2). Thus, it will be appreciated that depending on the consistency of the raw material 14 in the compression chamber 12 and the characteristics of the raw material 14 in the immediate vicinity of the compression elements 32, each of the dogs 32 will intrude into the chamber 12 until the resistance offered by the raw material 14 under compression is equal to the force imparted to that compression element 32 by its associated actuator 38. At this stage, the dogs 32 come to rest and are in equilibrium. The predetermined force applied to the dogs 32 is determined with a view to ensuring adequate compression and even density throughout the building block 16. It will be appreciated that this pressure may be varied, depending on circumstances relating to the composition of the raw materials 14 in use, its wetness, and other factors. The pressure plate 22 and dogs 32 are then allowed to relax, in order to allow for a certain amount of expansion of the compressed building block 16 and also to break any bond between the building block 16 and these components.

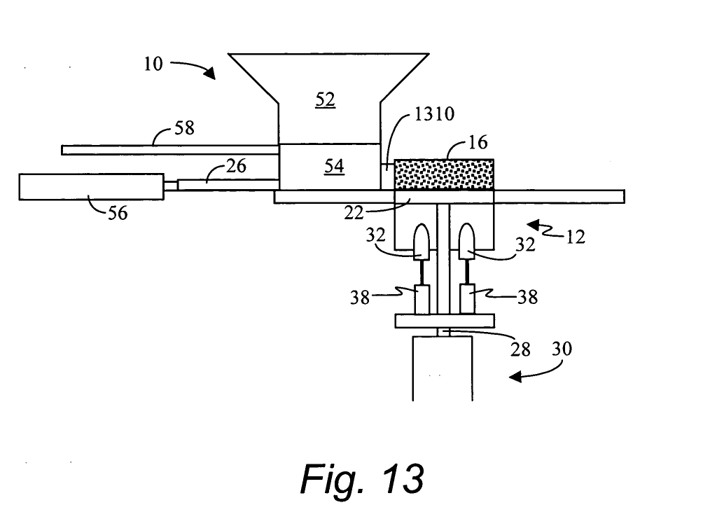

In FIG. 12, the feeder box 54 and the cover 26 of the compression chamber 12 are once again retracted, clearing the opening 24 of the compression chamber 12. In FIG. 13, the pressure plate 22 is once again urged, under operation of its associated hydraulic cylinder 30 to its upper limit (as shown by the pressure plate numbered 22.3 in FIG. 2), thereby extracting the completed compressed earthen building block 16 from the chamber 12. The compressed earthen building block 16 is then ejected laterally off of the pressure plate 22 by the movement of the feeder box 54 under the influence of the actuation of the horizontal hydraulic cylinder 56 as shown in FIG. 7, thereby completing the cycle. An elastic bumper 1310 helps protect the compressed earthen building blocks 16 from damage as they are pushed from the opening 24 compression chamber 12. The cycle is completed automatically by means of a hydraulic valve system (not shown) under the control of an operator or digital processor (not shown), to enable the automated processing of building blocks.

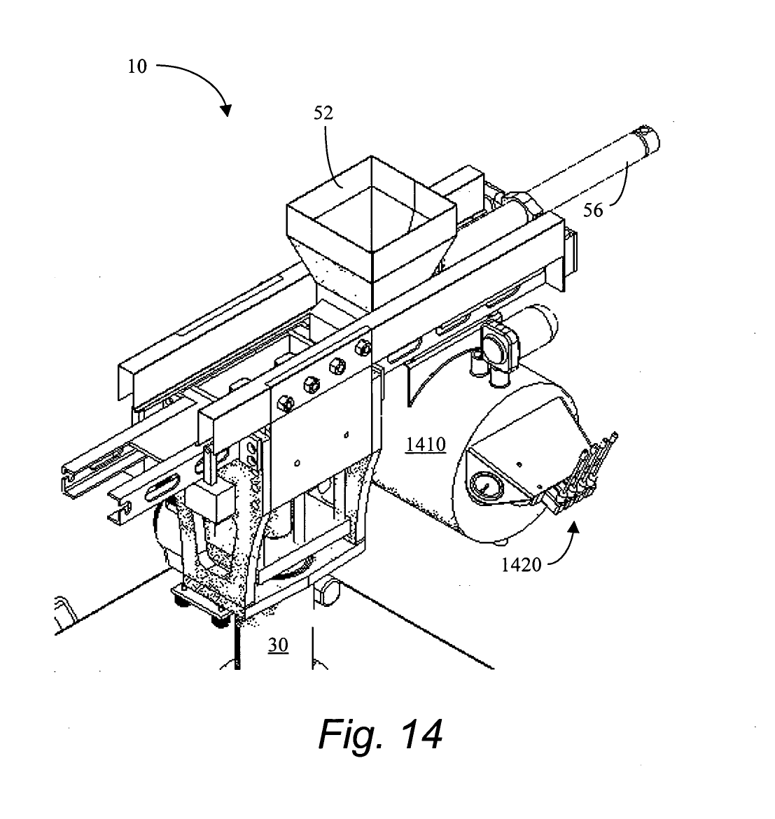

A perspective view of the compressed earthen building block apparatus 10 is shown in FIG. 14. In this view, a hydraulic fluid reservoir 1410 is clearly seen. Mounted on the hydraulic fluid reservoir 1410 are a set of control valves 1420. The valves 1420 are used to control the movement of the various hydraulic actuators, including those for the feeder box 54, the pressure plate 22, and the dogs 32. In the embodiment shown in FIGS. 14-21, the hopper 52 and feeder box 54 are integral, both sliding together.

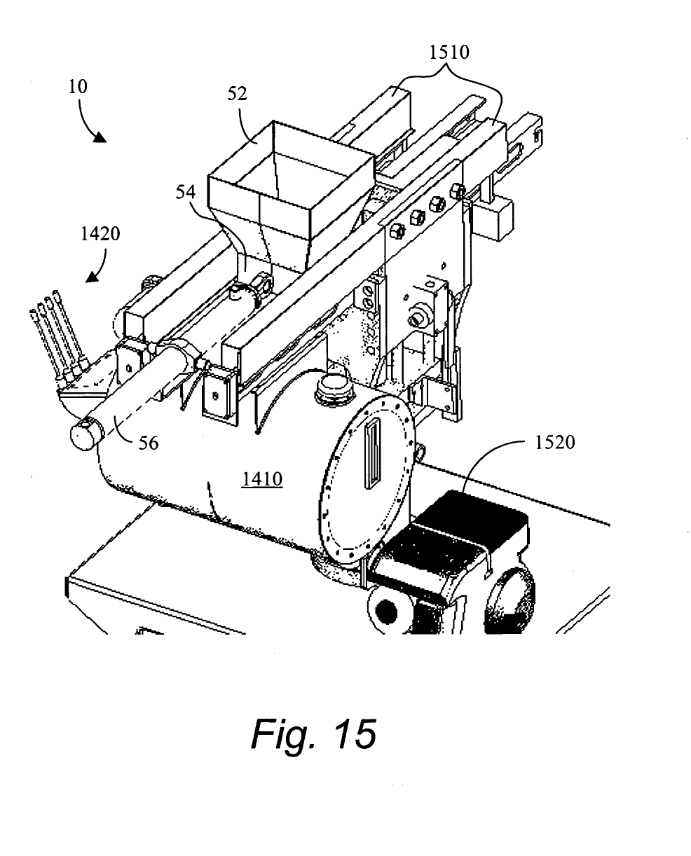

A perspective view of the apparatus of the present invention from another direction is shown in FIG. 15. The hydraulic cylinder 56 for the horizontal actuation of the feeder box 54 and cover plate 26 is clearly shown near the point of viewing of FIG. 15.

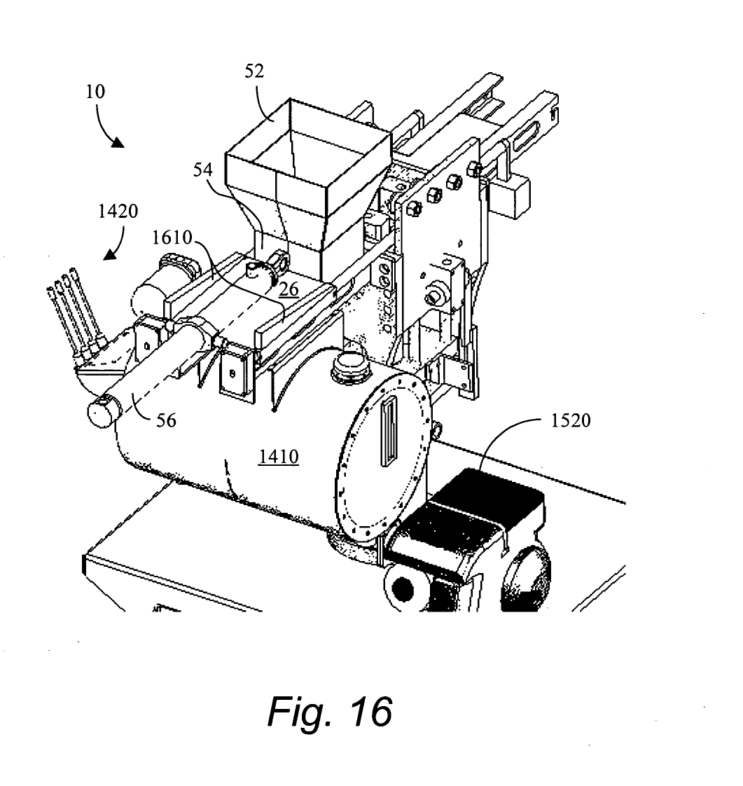

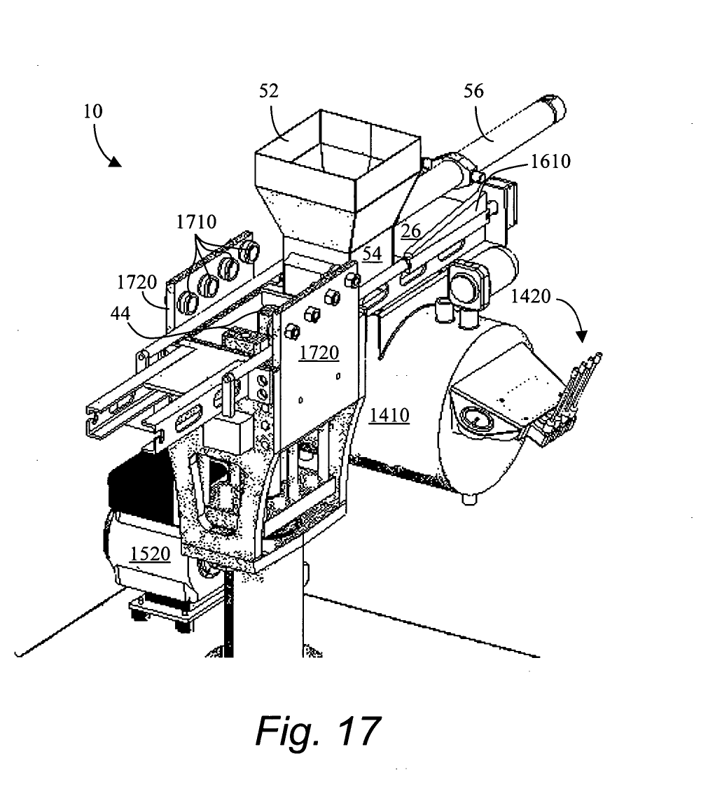

Dust covers 1510 provide protection for the wedges 1610 (see FIG. 16) and roller surfaces 1710 (see FIG. 17).

An engine 1520 provides shaft power for at least one hydraulic pump for pressurizing hydraulic fluid from the reservoir 1410 to the various hydraulic actuators 56, 30, 38 (only one hydraulic cylinder 56 shown in FIG. 15). The engine 1520 may also be used to provide electrical power for various operations on site such as running an electric motor for mixing the raw materials 14 used in the manufacture of the compressed earthen building blocks 16.

In FIG. 16, the same view as FIG. 15 is shown except that the dust covers 1510 have been removed for clarity. In FIGS. 16-21, the dust covers 1510 are not shown. The present invention may be practiced without the dust covers 1510, however, that is not the preferred embodiment.

Clearly seen in FIG. 16, is the cover plate 26. Integral with the cover plate are wedges 1610, with which the cover is secured down. This will be explained further with regard to FIGS. 17, 19-21, and 31-32.

The compression chamber 12 can be seen in FIG. 17. Tops of two pins 44 are seen inside the compression chamber 12.

A row of rollers 1710 may be seen on one side of the compression chamber 12. A similar row of rollers 1710 is located on the other side of the compression chamber 12 as well, but are blocked from view by a side plate 1720 closest to the point of viewing. The rollers 1710 are mounted on their respective side plates 1720.

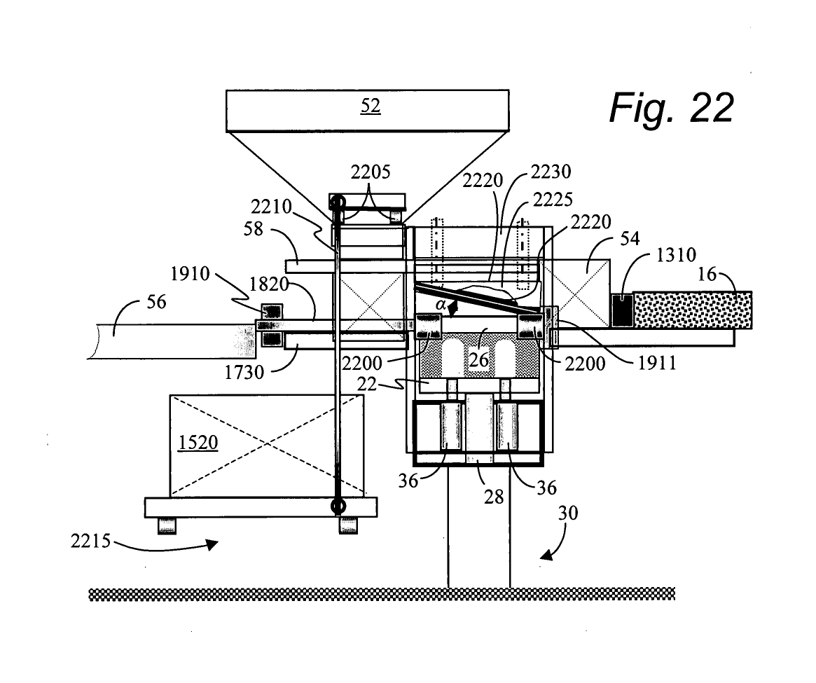

When the hydraulic cylinder 56 is actuated, as shown in FIG. 18, the sliding assembly 1810, including the feeder box 54, the hopper 52, and the cover plate 26 slides along guide rods 1820 (which are preferably chromed) by means of suitable sliding bushings 2200 (see FIG. 22). The cover plate 26 is located directly over the upper end 24 of the compression chamber 12.

A view more from the top is seen in FIG. 19. In this figure, the cover plate 26 is located directly over the upper end 24 of the compression chamber 12. The wedges 1610 have engaged the sets of rollers 1710 (only one full set visible in FIG. 19). As the wedges 1610 are forced under the rollers 1710, pressure is exerted downward because of the ramped wedge 1610 surfaces. The guide rods 1820 are mounted at each end in elastomer cushions 1910, 1911 which are capable of deflecting radially in all directions to accommodate any guide rod 1820 misalignment and to permit the cover plate 26 to be pressed down over the upper end 24 of the compression chamber 12, thereby sealing the compression chamber while pressure is applied to the raw materials 14 during the compressed earthen building block 16 making process.

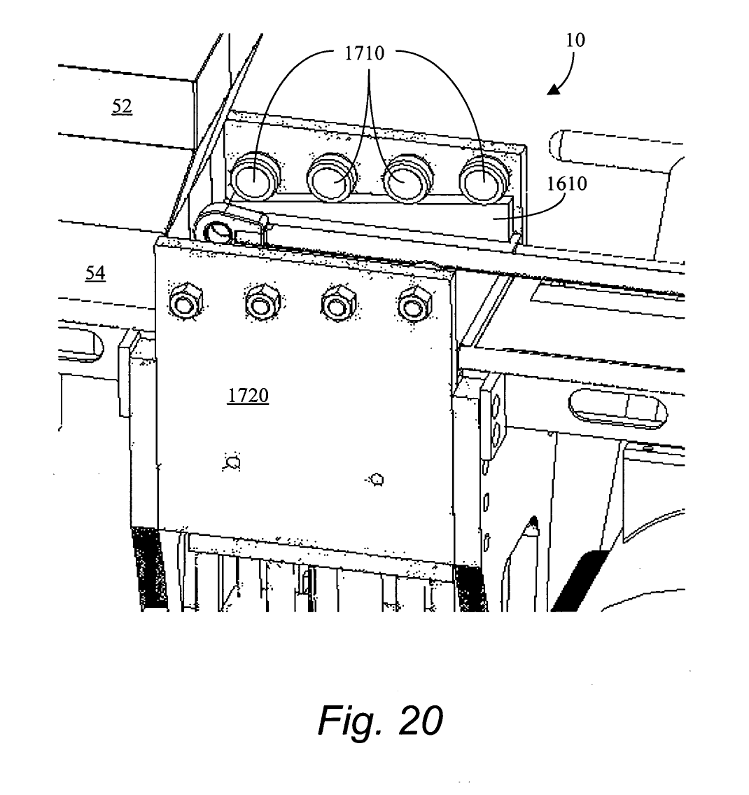

A detail of one of the two wedges 1610 is shown in FIG. 20 under the associated set of rollers 1710.

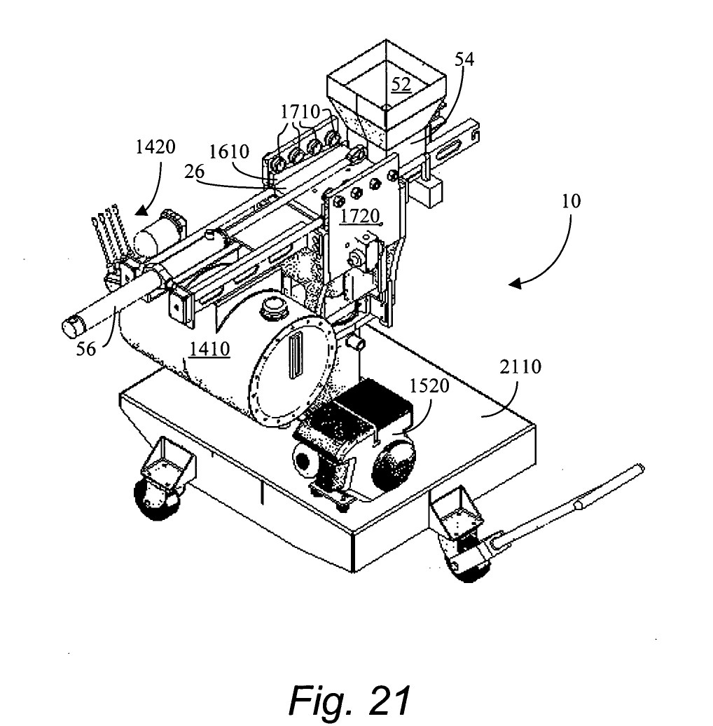

The compressed earthen building block apparatus 10 of the present invention is shown in FIG. 21 on a wheeled cart 2110 to make it mobile. Other options are to mount the compressed earthen building block apparatus 10 on a trailer or sled for towing behind a vehicle, or mounting the compressed earthen building block apparatus 10 permanently to a stationary surface.

Additional features of the present invention are shown in FIG. 22. The hopper 52 is shown mounted on elastomer mounts 2205. A rod 2210, attached to the motor mounting frame 2215 and the hopper 52, transmits vibration from the motor to the hopper to enable efficient and reliable feeding of the raw material 14 to the feeder box 54.

The guide rods 1820, on which the sliding assembly 1810 slides, deflect in the elastomer cushions 1910, 1911 over the compression chamber under the action of the wedge 1610. The angle, a, has been selected for this particular mechanism at a particular value to ensure the least friction and minimal energy losses and to minimize wear. The components in contact comprise two easily replaceable wear plates 2220.

Compressed earthen building blocks tend to be more compact in their centers than the outer edges. To counter this effect, upper plate supports 2225 replace the rollers 1710 in this embodiment. The upper plate supports 2225 have an arched void so the upward force from the hydraulic cylinder assembly 30 is shifted to the ends of the upper supporting beams 2230, thereby reducing bending or flexural stresses therein. In this way, compaction may be concentrated toward the edges of the compressed earthen building block 16, making a more homogeneous compressed earthen building block 16, even before the dogs 32 are inserted.

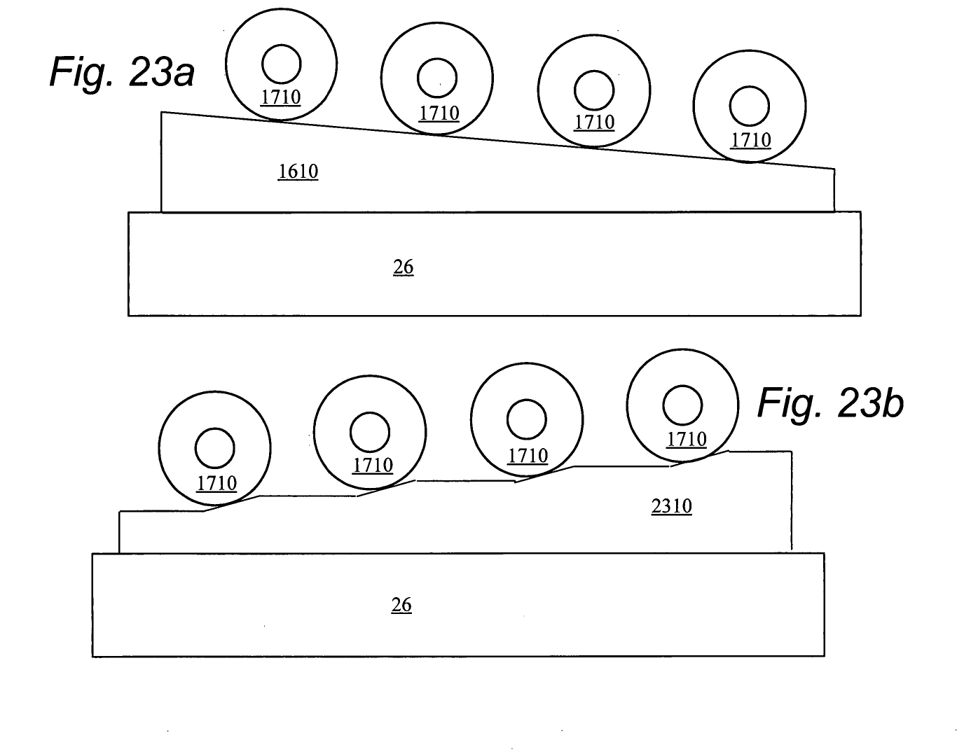

A detail of a wedge 1610 and associated rollers 1710 is shown in FIG. 23a. The hydraulic cylinder 56 forces the cover plate 26 and the wedge 1610 to the right in FIG. 23a in order to seal the compression chamber 12. The action of the wedge 1610 against the rollers 1710, under the force of the hydraulic cylinder 56, forces the cover plate 26 down over the upper end 24 of the compression chamber 12.

A stepped wedge 2310 shown in FIG. 23b represents an additional embodiment of the sealing system for the compressed earthen building block apparatus 10 of the present invention. An advantage is realized in this design in that different values of the angle, α, may be adopted without changing the height of the wedge 2310 assembly.

The cover plate assembly, examples of which are shown in FIGS. 23a and 23b, evidently does not require a strict wedge shape. The profile must be wedge-like, in that a portion of the profile at one end of the assembly must be lower than the portion of the profile at the other end. If the cover plate assembly is to engage more than one roller, the general trend from the lower end to the upper end must be increasing in height.

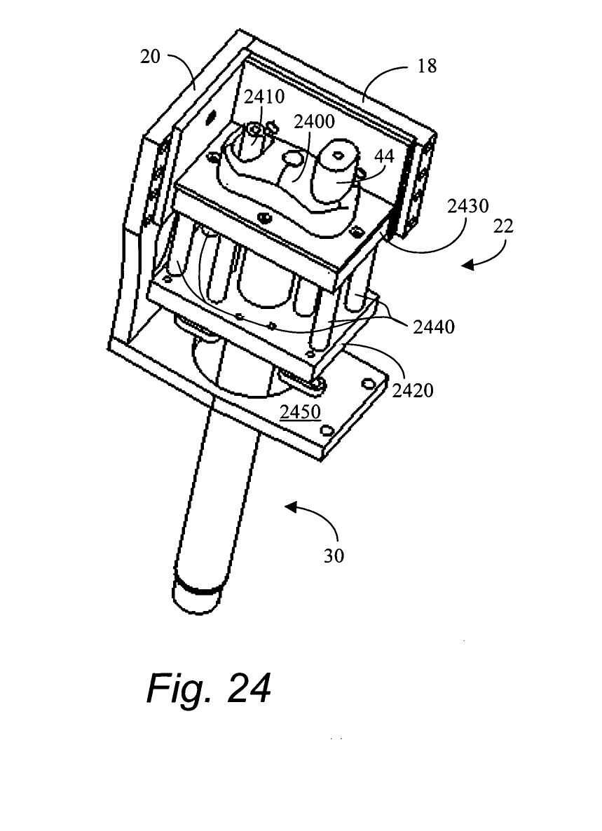

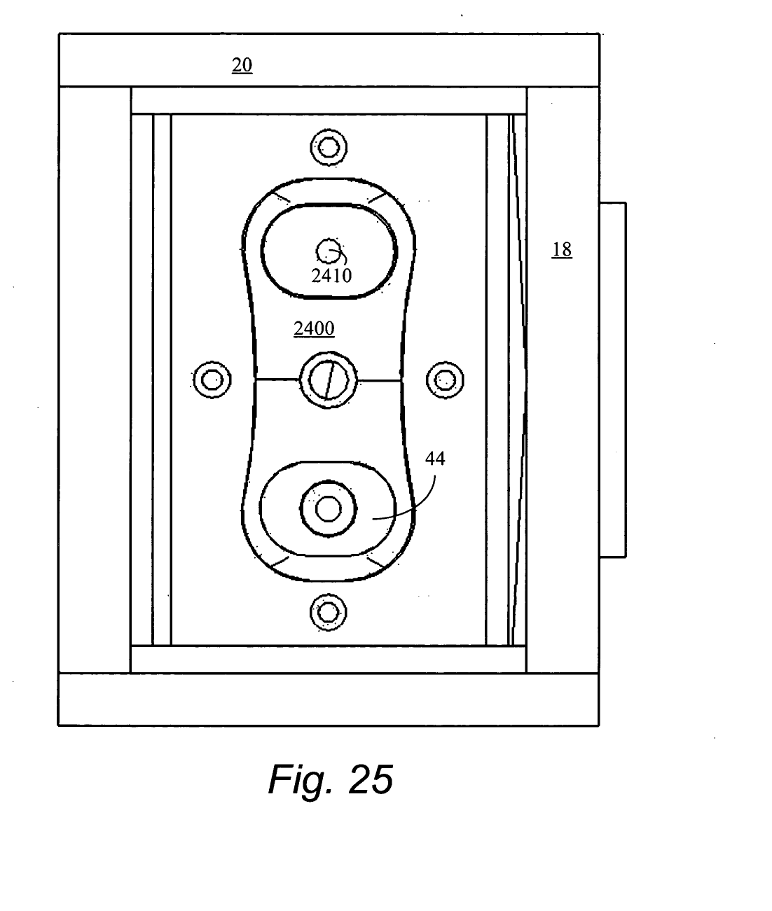

The compression elements, or dogs 32, shown in FIGS. 1-13 is a first embodiment of this part of the invention. A second embodiment is shown in FIGS. 24 and 25 wherein a single dog 2400 is used. As is most clearly seen in FIG. 25, the dog 2400 has a dog-bone or dumbbell shape that is narrower in the center and broader at the ends. Only one static pin 44 is shown in FIGS. 24 and 25. Where the other static pin 44 has been removed, a mounting rod 2410 to which the pin would be attached is visible.

Another feature shown most clearly in FIG. 24 is a two-level pressure plate 22. The hydraulic cylinder assembly 30 connects to the lower plate 2420. The lower plate 2420 has an aperture in it for passing a portion of the hydraulic cylinder assembly 30. The lower plate 2420 connects rigidly to an upper plate 2430, which engages the raw materials 14 to produce a compressed earthen building block 16. A space between the lower plate 2420 and the upper plate 2430, as well as the rigid connection, is effected via standoffs 2440. A compression box lower plate 2450 provides structure and rigidity to the compression box 12.

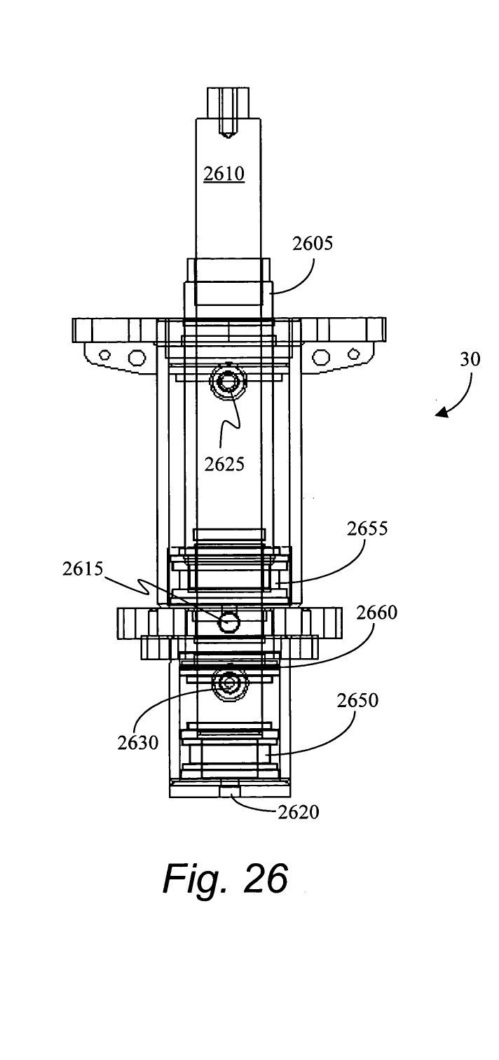

To provide independent action of the lower plate 22 and the dog 2400, a novel hydraulic cylinder assembly 30 is provided the present invention and is shown in FIG. 26. This hydraulic cylinder assembly 30 comprises two (2) rams 2605, 2610. The outer ram 2605 is hollow and actuates the pressure plate 22. The inner ram 2610 travels inside the hollow, outer ram 2605 and actuates the dog 2400. Hydraulic fluid enters the hydraulic cylinder under pressure to force the outer ram upward at the outer ram lower port 2615 while hydraulic fluid enters the hydraulic cylinder under pressure to force the outer ram downward at the outer ram upper port 2625. Similarly, the inner ram 2610 is forced upward by hydraulic fluid entering the inner ram lower port 2620 under pressure, where the hydraulic fluid bears on the entire circular surface of the upper ram piston 2650. The inner ram 2610 is forced downward by hydraulic fluid entering the inner ram upper port 2630. The surfaces on which the pressurized hydraulic fluid act on the rams' pistons 2650, 2655 are annular in shape, with the previously mentioned exception of the bottom surface of the inner ram's piston 2650.

A seal 2660 isolates the pressurized fluid acting on the two rams 2605, 2610. In this way, the two rams 2605, 2610 may be actuated independently, while remaining coaxial.

An additional aspect of the present invention is a method and apparatus for accurately determining a volume of raw material 14 with which to begin to produce a compressed earthen building block 16 of consistent dimension and density without resorting to the trial and error method of the prior art. In each of the following embodiments, a sample of the raw materials 14 is inserted in a calibration apparatus and compressed under the same pressure as it would experience in the compressed earthen block apparatus 10. The volume of raw material 14 to be loaded into the compression chamber 12 may be calculated as:

$${– V}_{1} = {– V}_{2} \frac{{v}_{1}}{{v}_{2}} = {– V}_{2} ( \frac{Δ v}{{v}_{2}} + 1 )$$

where:
₁ is the initial (uncompressed) volume of raw material 14 loaded into the compression chamber 12,
₂ is the terminal volume of the finished block 16 based on the terminal volume of the compression chamber 12,
v₁ is the initial (uncompressed) volume of raw material 14 loaded into the calibration unit,
v₂ is the final volume (after compression) of the raw material 14 in the calibration unit, and
   Δv=v₁−v₂.

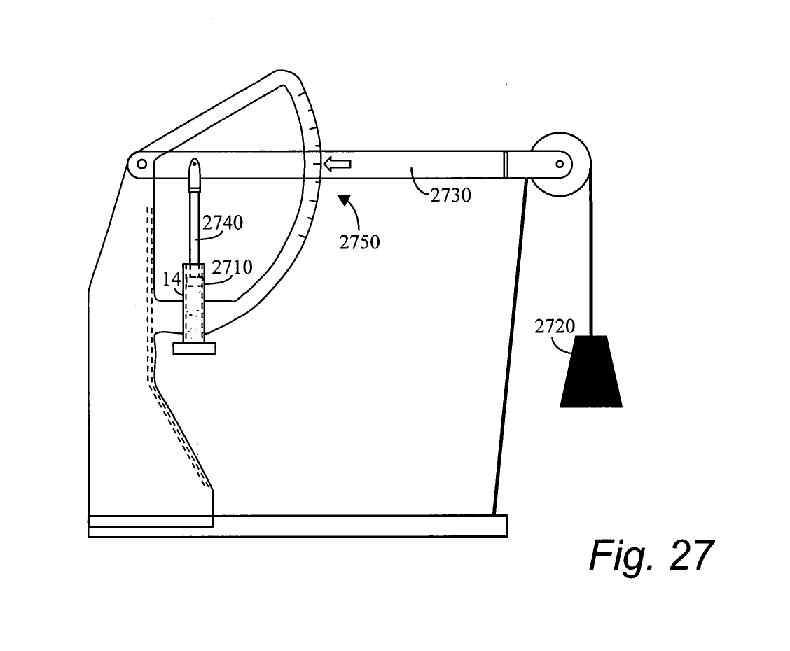

The various embodiments illustrated in FIGS. 27-32 vary only in the manner in which the force is generated to compress the raw materials 14.

A first embodiment of a calibration unit is shown in FIG. 27. The calibration cylinder 2710 is filled with a known volume of raw material 14, such as a complete calibration cylinder 2710 full. A weight 2720 has been sized to provide a pressure in the calibration cylinder 2710 equal to that which will be experienced in the compression chamber of the compressed earthen building block apparatus 10. The weight 2720 apples a force at the end of a lever arm 2730 to which a piston 2740 is operatively, pivotally attached. The lower end of the piston 2740 engages the raw materials 14 in the calibration cylinder 2710. After the lever arm 2730 and weight 2720 have ceased their descent, the sample has achieved its full compression as it would in the compression chamber 12 of the compressed earthen building block apparatus 10. The amount of compression may be read off a scale 2750 which may be graduated into units representing either v₂ or Av.

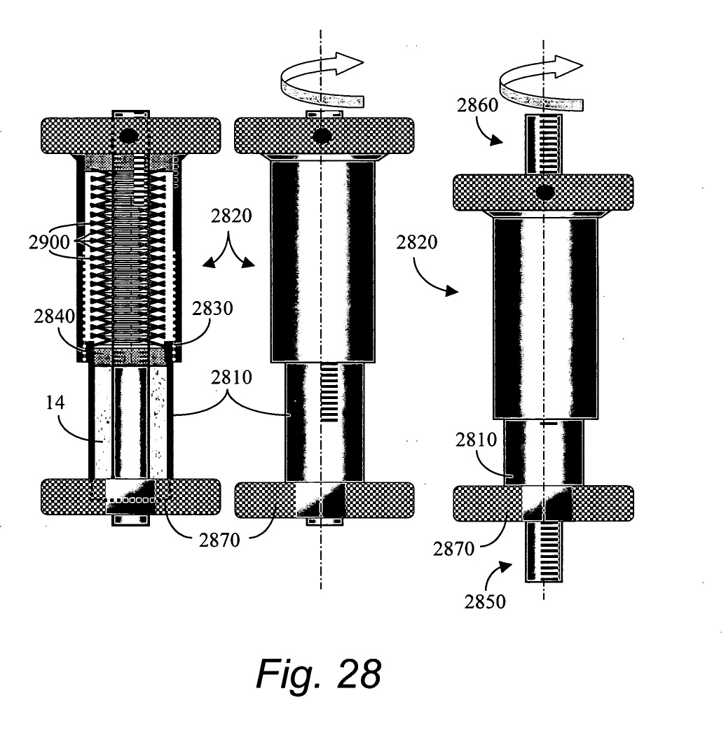

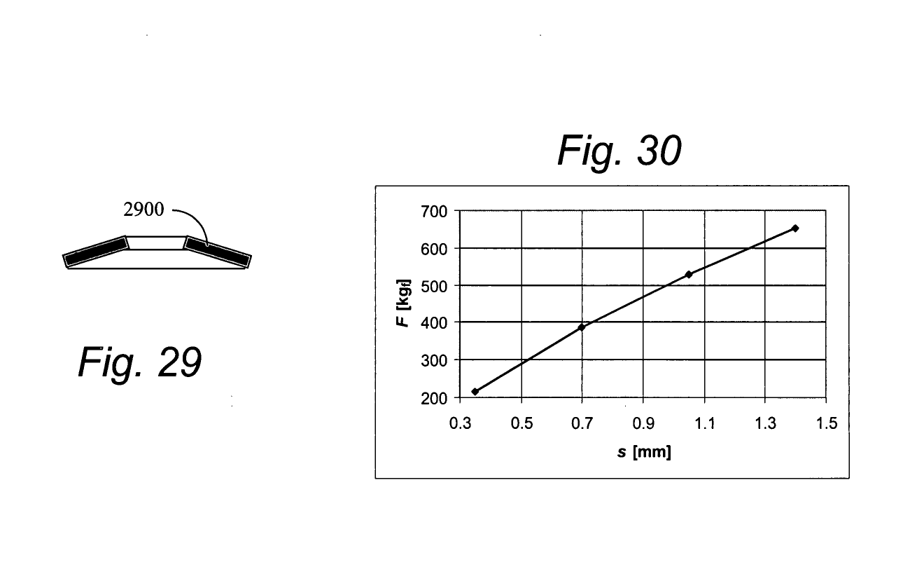

A second embodiment of a calibration unit is shown in FIG. 28. In this embodiment, disc springs 2900 as detailed in FIG. 29 are used to apply the force to the raw materials 14. Again, a cylinder 2800 is filled with raw materials 14, in this case, from the bottom of the cylinder 2810 as shown in FIG. 28. A force mechanism 2820 is threaded down over the cylinder 2810 via threads 2830. The force mechanism 2820 comprises a piston 2840 that engages the raw materials 14, and a plurality of disc springs 2900. An example of a force-displacement spring characteristics plot is shown in FIG. 30. In this embodiment, an operator must keep track of both the compression amount via a lower scale 2850 that moves with the piston 2840 and an upper scale 2860 that is stationary with respect to a lower knob 2870. In this way, the compression of the springs 2900 may be calculated by subtracting the length of the lower scale 2850 from that of the upper scale 2860. Based on the stress-strain relationship shown in FIG. 30, the springs 2900 will be compressed a known amount in order to achieve the same pressure as that of the compression chamber 12 of the compressed earthen building block apparatus 10.

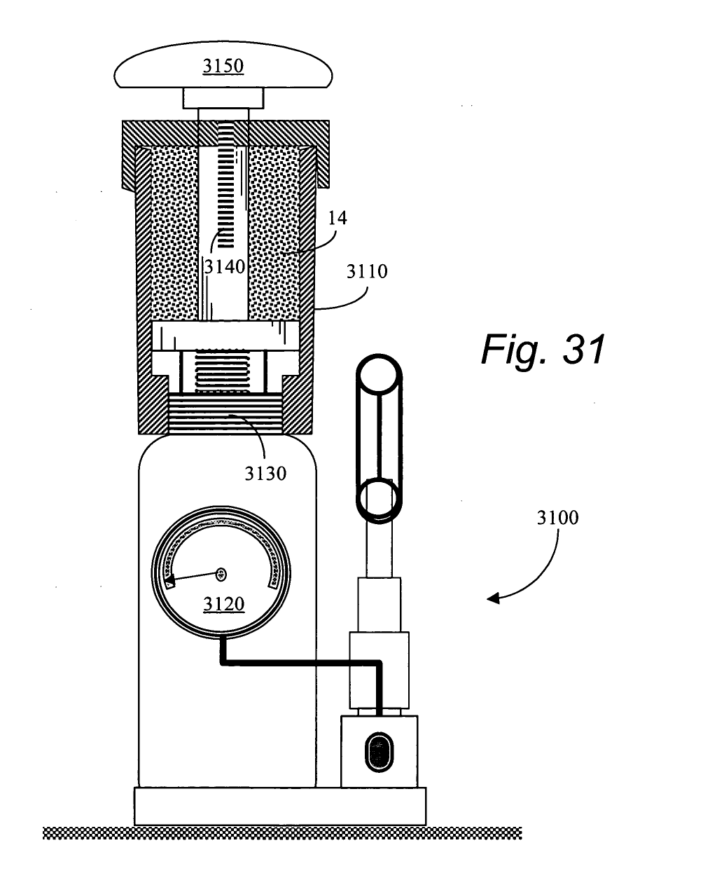

Another embodiment of the calibration unit is shown in FIG. 31. Here again, a cylinder 3110 is filled with a known volume of raw materials 14. The force, in this embodiment, is produced by a hydraulic bottle jack 3100. A pressure gage 3120 may be calibrated to provide a reading of the pressure in the cylinder 3110. Alternatively, the actual pressure in the hydraulic bottle jack 3100 may be converted to the pressure in the cylinder 3110 with a simple scaling constant. The cylinder 3110 is filled with raw materials 14, and threaded down over threads 3130 on a neck of the hydraulic bottle jack 3100. Pressure is applied to the raw materials 14 by pumping the handle (not shown) of the hydraulic bottle jack 3100 until the same pressure is reached in the cylinder 3110 as will be realized in the compression chamber 12 of the compressed earthen building block apparatus 10. The amount of compression is read from the scale 3140. Again, the scale 3140 may be in terms of v₂ or Δv. The knob 3150 on top may be used to manually press the hydraulic bottle jack's 3100 piston back to its lowered position.

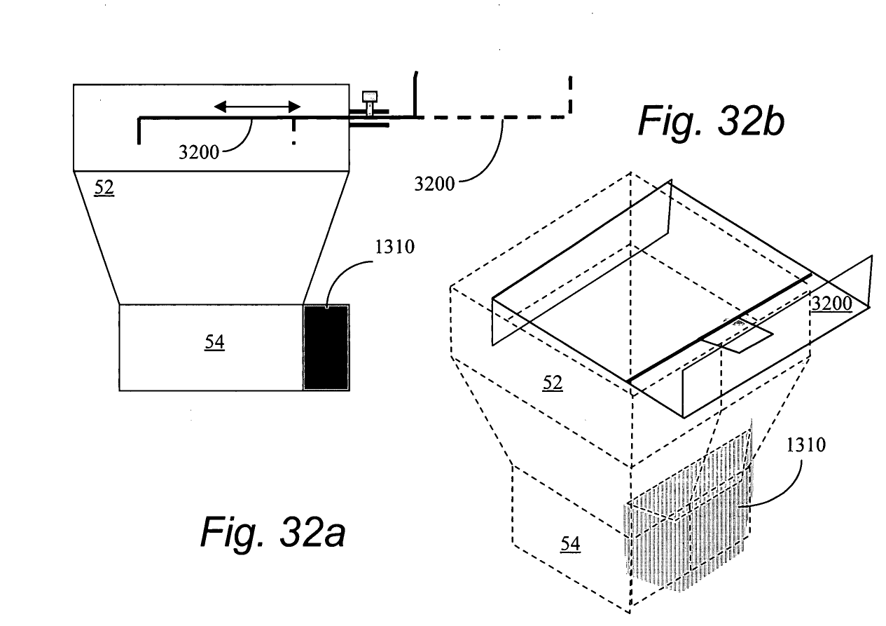

Once the appropriate initial volume of raw materials 14 has been calculated using measurements from one of the calibration units, it is prudent to modify the hopper 52 to automatically receive only this volume of raw material. A first embodiment of such a modification is shown in FIGS. 32a and 32b. A sliding plate 3200 may be adjusted to vary the top opening of the hopper 32. The result is an empty space, void of raw materials 14 under the sliding plate 3200, effectively reducing the amount of raw materials 14 loaded into the hopper 52 at each charge.

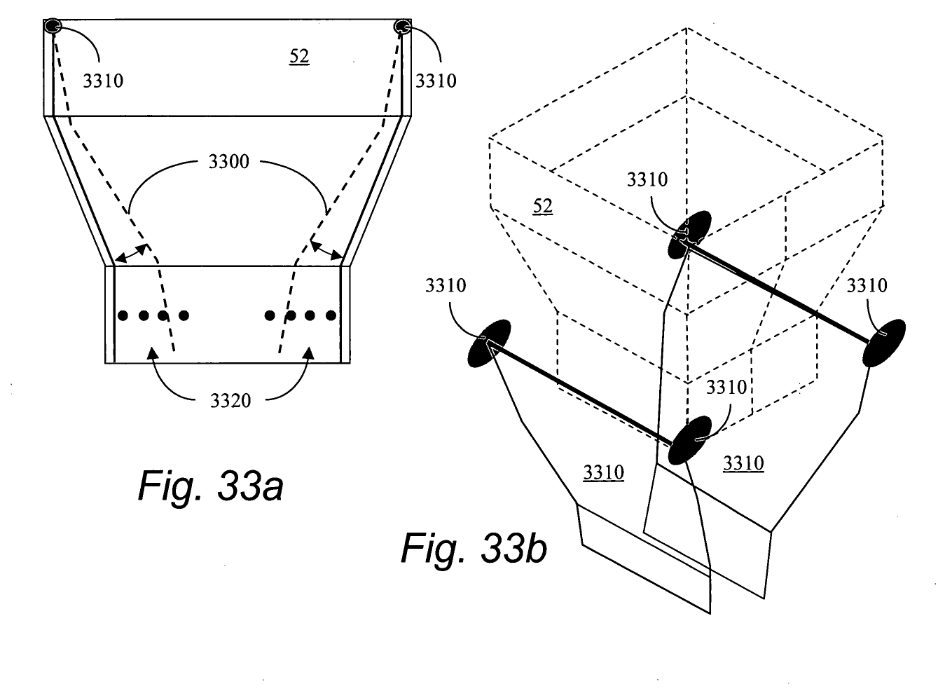

A second embodiment of an apparatus for gauging the initial charge of raw materials 14 in the hopper is shown in FIGS. 33a and 33b. In this embodiment, adjustable wings 3300 pivot at the top at hinges 3310. Pins or rods passed through appropriate holes 3320 are used to hold the wings 3300 in place.

By means of the invention, there is provided an apparatus 10 and a method for the production of earth-based building blocks 16 used in construction that enable the production of compressed earthen building blocks 16 having a high degree of homogeneity, consistent density of material throughout the block, and the achievement of compression pressures throughout the block during the course of construction that facilitate the creation of hard-wearing building blocks having a high degree of dimensional precision. Further, the energy required in the compression of blocks 16 is reduced in comparison with existing methods for the production of similar blocks. Since the pressures involved in the manufacture of the building blocks 16 are relatively reduced, the power requirements of the apparatus are similarly reduced and the size of the apparatus is sufficiently small to be readily transported on a road trailer for use on site.

The above embodiments are the preferred embodiments, but this invention is not limited thereto. It is, therefore, apparent that many modifications and variations of the present invention are possible in light of the above teachings. It is, therefore, to be understood that within the scope of the appended claims, the invention may be practiced otherwise than as specifically described.

1. A method of producing compressed earthen building blocks from raw materials comprising earth and using a compressed earthen building block producing machine comprising a compression chamber, at least one compression element, or dog, and at least one compression element actuator for actuating said at least one compression element, the method comprising the steps of:
(a) compressing the raw materials to a block of predetermined size in the compression chamber; and
(b) forcing the at least one compression element into the sized block while the sized block remains under pressure, said at least one compression element being forced until said at least one compression element actuator achieves a predetermined pressure and the at least one compression element ceases motion, said compression element producing a recess in said sized block.

2. The method of claim 1 wherein the step of compressing the raw materials comprises the steps of:
(a) filling the compression chamber with the raw materials; and
(b) reducing a volume of said raw materials by a movement of at least one wall of the compression chamber.

3. The method of claim 2 including the step of ceasing the movement of the at least one wall of the compression chamber at a predetermined location.

4. The method of claim 2 additionally comprising the steps of:
(a) actuating an outer ram to move the at least one wall of the compression chamber, said outer ram being hollow; and
(b) actuating an inner ram to force the at least one compression element into the sized block, said inner ram being located inside and coaxial with the upper ram.

5. The method of claim 2 the step of filling the compression chamber with raw materials comprising the steps of:
(a) measuring a volume of a sample of the raw materials;
(b) compressing the sample of the raw materials to the predetermined pressure;
(c) measuring a final volume of the sample of raw materials; and
(d) calculating an initial volume of raw materials for filling the compression chamber with raw materials.

6. The method of claim 1 wherein the compression chamber comprises a cover plate having a wedge profile, and at least one roller, not extending entirely across the compression chamber, under which the wedge is forced, the method comprising the additional steps of:
(a) filling the compression chamber with the raw materials;
(b) covering the compression chamber with the cover plate having the wedge profile and engaging the wedge profile under the at least one roller; and
(c) forcing the cover plate down over the compression chamber by forcing the wedge profile under the at least one roller.

7. The method of claim 1, the compressed earthen building blocks producing machine additionally comprising a hopper into which raw materials may be charged before said raw materials enter the compression chamber, said method comprising:
(a) slidingly affixing a sliding plate to a top of said hopper; and
(b) sliding the sliding plate to alter the area of the top of the hopper, thereby altering a charge volume of raw materials into the hopper.

8. The method of claim 1, the compressed earthen building blocks producing machine additionally comprising a hopper into which raw materials may be charged before said raw materials enter the compression chamber, said method comprising:
(a) pivotally attaching at least one wing to an inside of said hopper, the at least one wing being pivotally attached at a top of the at least one wing; and
(b) pivoting the at least one wing from the wing top to swing a bottom of the at least one wing to alter a volume holdable by the hopper.

9. An apparatus for a manufacture of compressed earthen building blocks, said apparatus comprising:
(a) a compression chamber having at least one movable wall for changing a volume of the compression chamber;
(b) at least one compression element, or dog, insertable into the compression chamber through at least one wall of the compression chamber wherein a cross-sectional area of a projection of the compression element on a plane of the at least one wall is less than an area of the at least one wall, said compression element for further altering the volume of the compression chamber.

10. The apparatus of claim 9 additionally comprising at least one actuator for inserting the compression element into the compression chamber, said actuator applying a predetermined maximum pressure to the compression element.

11. The apparatus of claim 10 wherein the at least one actuator comprises:
(a) a hollow outer ram for actuating the at least one movable wall;
(b) an inner ram, slidably engaged and coaxial with the hollow outer ram, said inner ram for actuating the at least one compression element; and
(c) means for actuating the outer ram and the inner ram independently of one another.

12. The apparatus of claim 11 wherein the at least one actuator comprises at least one hydraulic cylinder.

13. The apparatus of claim 11 wherein the hydraulic cylinder also includes a cylinder inside which both the inner and the outer rams are slidable, the cylinder having one open end through which both the inner and the outer rams protrude and a substantially closed end, the means for actuating the outer ram and the inner ram independently of one another comprises:
(a) a first piston operably affixed to the inner ram near an end of the inner ram inside the cylinder;
(b) a second piston operably affixed to the hollow, outer ram near an end of the hollow outer ram inside the cylinder, said second piston being nearer the open end of the cylinder than the first piston;
(c) a first hydraulic fluid port closer to the substantially closed end of the cylinder than the first piston;
(d) a second hydraulic fluid port closer to the open end of the cylinder than the first piston;
(e) a third hydraulic fluid port closer to the substantially closed end of the cylinder than the second piston;
(f) a fourth hydraulic fluid port closer to the open end of the cylinder than the second piston; and
(g) a seal, stationary with respect to the cylinder, and residing between the first and second pistons and between the second and third hydraulic fluid ports.

14. The apparatus of claim 9 additionally comprising a sealing assembly for sealing an opening in the compression chamber, said sealing assembly comprising:
(a) a slidable cover that traverses linearly over the opening in the compression chamber;
(b) a wedge-like profile, generally increasing in thickness from a first end of the slidable cover to a second, opposite end, said first and second ends being opposite one another in a direction of sliding; and
(c) at least one roller, an axial dimension of the at least one roller extending incompletely across said opening in the compression chamber, said at least one roller engaging the wedge-like profile to force the slidable cover towards the compression chamber.

15. The apparatus of claim 14 wherein the wedge-like profile is a wedge shaped profile.

16. The apparatus of claim 14 wherein the wedge-like profile is a stepped wedge profile.

17. The apparatus of claim 9 additionally comprising a sealing assembly for sealing an opening in the compression chamber, said sealing assembly comprising:
(a) a slidable cover that traverses linearly over the opening in the compression chamber;
(b) a wedge-like profile, generally increasing in thickness from a first end of the slidable cover to a second, opposite end, said ends being opposite one another in a direction of sliding; and
(c) an upper plate support, a profile of which has an arched void in its center, ends of the upper plate support engaging the first and second ends of the wedge-like profile.

18. The apparatus of claim 9 additionally comprising:
(a) a hopper for ease of charging the compressed earthen block producing apparatus with raw materials, said hopper being mounted on at least one elastomer mount;
(b) a feeder box into which the raw materials drop from the hopper and from which the raw materials drop into the compression chamber;
(c) an engine to provide shaft power, said engine mounted on at least one elastomer mount; and
(d) a rigid member extending from the engine to the hopper to transmit vibration from the engine to the hopper to assist in feeding the raw material into the feeder box.

19. The apparatus of claim 9 wherein the at least one compression element has a cross-sectional shape having broader ends compared to a narrower center.

20. The apparatus of claim 9 wherein the at least one compression element comprises at least one pin having a cross-sectional area less than the cross-sectional area of the at least one compression element and extending from the at least one compression element to a cover plate on the compression chamber, said at least one pin producing a void in a finished compressed earthen building block passing entirely through said compressed earthen building block.

21. The apparatus of claim 20 wherein the at least one pin is stationary with respect to the compression chamber, an axis of the at least one pin being oriented parallel to a direction of travel of the at least one compression element, said at least one compression element being slidably attached to the at least one pin.

22. The apparatus of claim 18 additionally comprising:
(a) a cover plate, operatively attached to the feeder box;
(b) at least one rod on which the cover plate and feeder box are slidably attached; and
(c) at least one feeder box actuator to slide the feeder box and cover plate, in one extreme of travel access is provided to an opening in the compression chamber, in another extreme of travel the opening in the compression chamber is sealed by the cover plate.

23. The apparatus of claim 22 additionally comprising an elastic block operatively attached to the feeder box and oriented to push a finished compressed earthen building block from the opening in the compression chamber, the elastic block minimizing damage to the finished compressed earthen building block.

24. The apparatus of claim 18 wherein the hopper comprises a sliding plate covering a portion of said hopper and slidingly adjustable to vary a hopper opening size.

25. The apparatus of claim 18 wherein the hopper comprises at least one wing, shaped to fit against a side of said hopper and hinged at a top of the at least one wing, said at least one wing being pivoted to alter a volume holdable by the hopper.

26. A method of assembling a hydraulic cylinder in which two separate, coaxial rams may be independently actuated, the hydraulic cylinder comprising a cylinder having an open end and a substantially closed end, a hollow, outer ram, an inner ram, both rams protruding from the cylinder through the cylinder's open end, a first and second piston and a first, second, third, and fourth hydraulic fluid port, the method comprising the steps of:
(a) slidably inserting the inner ram inside and coaxially with the hollow, outer ram;
(b) rigidly, operatively attaching the first piston to the inner ram near an end of the inner ram;
(c) rigidly, operatively attaching the second piston near an end of the hollow outer ram, said end being adjacent to the end of the inner ram to which the first piston was operably attached;
(d) machining the first hydraulic fluid port in the cylinder at the substantially closed end of the cylinder;
(e) machining the second hydraulic fluid port in the cylinder nearer the open end of the cylinder than the first hydraulic fluid port;
(f) machining the third hydraulic fluid port in the cylinder nearer the open end of the cylinder than the second hydraulic fluid port;
(g) machining the fourth hydraulic fluid port in the cylinder nearer the open end of the cylinder than the third hydraulic fluid port;
(h) assembling the inner ram, the hollow, outer ram, and the first and second pistons, all coaxially, in the cylinder;
(h) installing a seal, stationary with respect to the cylinder, and residing between the first and second pistons and between the second and third hydraulic fluid ports.

27. A hydraulic cylinder in which two separate, coaxial rams may be independently actuated, the hydraulic cylinder comprising:
(a) a cylinder having an open end and a substantially closed end;
(b) a hollow, outer ram protruding from the open end of the cylinder;
(c) an inner ram, protruding from the open end of the cylinder and residing coaxially inside the hollow, outer ram;
(d) a first piston operatively, rigidly attached to an end of the hollow, outer ram, said end being inside the cylinder;
(e) a second piston operatively, rigidly attached to an end of the inner ram, said end being inside the cylinder;
(f) a first seal located between the first and second pistons and being stationary with respect to the cylinder;
(g) a second seal near the open end of the cylinder;
(h) a first hydraulic fluid port located between the substantially closed end of the cylinder and the second piston;
(i) a second hydraulic fluid port located between the second piston and the first seal;
(j) a third hydraulic fluid port located between the first seal and the first piston; and
(k) a fourth hydraulic fluid port located between the first piston and the second seal.

28. An apparatus for sealing an opening in a compression chamber in a machine for producing compressed earthen building blocks, the apparatus comprising:
(a) a slidable cover that traverses linearly over the opening in the compression chamber;
(b) a wedge-like profile, generally increasing in thickness from one end of the slidable cover to an opposite end, said ends being opposite one another in a direction of sliding; and
(c) at least one roller, an axial dimension of the at least one roller extending only partially across said opening in the compression chamber, said at least one roller engaging the wedge-like profile to force the slidable cover towards the compression chamber.

29. The apparatus of claim 28 additionally comprising:
(a) at least one rod along which the slidable cover slides;
(b) at least one bushing, operatively, rigidly attached to the slidable cover and slidingly affixed to the at least one rod; and
(c) elastomer mounts to which the at least one rod is affixed, providing elastic deflection in a radial direction of the at least one rod.

30. A method of determining an appropriate initial volume of raw materials to load into a device for producing compressed earthen building blocks, said device compressing the raw materials in a compression chamber to a predetermined pressure, said method comprising the steps of:
(a) collecting a sample of the raw materials, said sample having a predetermined volume;
(b) compressing the raw materials under the predetermined pressure of the device for producing compressed earthen building blocks;
(c) measuring a value related to a final volume of said sample of the raw materials; and
(d) calculating an initial volume of raw materials for filling the compression chamber of the device for producing compressed earthen building blocks as a function of the final volume of said sample of the raw materials.

31. The method of claim 30 wherein the step of compressing the raw materials comprises the steps of:
(a) placing the sample of raw materials into a calibration unit's compression chamber against a movable wall; and
(b) applying a force to the movable wall such that a final pressure on the raw materials due to the force is equal to the predetermined pressure of the device for producing compressed earthen building blocks.

32. The method of claim 31 wherein the force is applied by a weight under gravity.

33. The method of claim 32 wherein a lever arm having two ends is used, the step of applying the force to the movable wall comprises the steps of:
(a) pivotally attaching the lever arm near a first end of the lever arm to a first pivot, said first pivot being stationary with respect to the calibration unit's compression chamber;
(b) operably, pivotally attaching the lever arm to a second pivot, said second pivot being operably connected to the movable wall and being closer to a second end of the lever arm than the first pivot; and
(c) applying a weight near the second end of the lever arm to force the movable wall toward the raw materials.

34. The method of claim 31 wherein the force is applied by a spring.

35. The method of claim 34 additionally comprising measuring a length of compression of the spring.

36. The method of claim 31 wherein the force is applied by a hydraulic bottle jack.

37. The method of claim 36 additionally comprising measuring a pressure of hydraulic fluid in the hydraulic bottle jack and displaying a value related to said pressure measurement.
